(19) United States
(12) Patent Application Publication
(10) Pub. No.: US 2023/0057808 A1
(43) Pub. Date: Feb. 23, 2023

(54) WIRELESS TAG READING DEVICE

(71) Applicant: TOSHIBA TEC KABUSHIKI KAISHA, Tokyo (JP)

(72) Inventor: Osamu WATANABE, Tokyo (JP)

(21) Appl. No.: 17/982,814

(22) Filed: Nov. 8, 2022

Related U.S. Application Data
(63) Continuation of application No. PCT/JP2021/032052, filed on Sep. 1, 2021.

(30) Foreign Application Priority Data
Sep. 25, 2020 (JP) 2020-160592

(51) Int. Cl. G07G 1/01; G07G 1/00

(52) U.S. Cl. CPC G07G 1/01; G07G 1/0081; G07G 1/009

(57) ABSTRACT

A wireless tag reading device of an embodiment includes: a housing portion formed by a bottom surface portion and a side surface portion erected upward from the bottom surface portion; an opening through which an article is allowed to be taken in and out of the housing portion; a reading unit that reads tag information from a wireless tag attached to the article housed in the housing portion via the opening by transmitting and receiving a radio wave to and from the wireless tag; a detection unit that detects a position of the article in the housing portion; and an announcement unit that makes an announcement to prompt approach of the article to a predetermined position of the housing portion based on output of the detection unit.

### CROSS-REFERENCE TO RELATED APPLICATIONS

This application is a national stage application of International Application No. PCT/JP2021/032052, filed Sep. 1, 2021, which designates the United States, and which claims the benefit of priority from Japanese Patent Application No. 2020-160592, filed Sep. 25, 2020, the entire contents of which are incorporated herein by reference.

### FIELD

An embodiment of the present invention relates to a wireless tag reading device.

### BACKGROUND

These days, wireless tag reading devices are adopted in stores such as supermarkets and mass retailers. A wireless tag is attached to a product to be sold in a store. A wireless tag reading device reads information on a product to be purchased by a customer from the wireless tag. The product to be purchased by a customer is put into, for example, a basket, and brought to a checkout counter. The basket containing the product is housed in a housing portion, and an antenna transmits and receives radio waves to and from the wireless tag attached to the product. The wireless tag reading device provided in the checkout counter thereby reads tag information from the wireless tag.

The tag information read by the wireless tag reading device, for example, information related to a product such as a product code for identifying a product is transmitted to the POS terminal. The POS terminal performs settlement processing based on the received information related to the product. The customer himself/herself or a clerk performs operation related to the settlement processing.

There is known this type of wireless tag reading device including a box-shaped housing portion with an upper surface opening (e.g., Patent Literature 1). The wireless tag reading device has a box shape with the upper surface of the housing portion being opened, and can prevent leakage of radio waves since the periphery thereof is surrounded. As a result, inadvertent reading of tag information of a wireless tag located outside the housing portion is inhibited.

In the above-described conventional technique, however, it is necessary to lift a basket and house the basket from the upper surface opening into the housing portion, and there is room for improvement in terms of operability. It has also been studied to provide an opening for taking the basket in and out of the housing portion on the side surface of the housing portion, but, in this case, radio waves may easily leak, and tag information of a wireless tag outside the housing portion may be erroneously read (hereinafter, also referred to as erroneous reading). Thus, in the wireless tag reading device, improvement of the operability is demanded together with inhibition of the erroneous reading. Note that this demand is not limited to the wireless tag reading device connected to the above-described POS terminal.

It is thus preferable to provide a wireless tag reading device capable of improving operability while inhibiting erroneous reading.

### BRIEF DESCRIPTION OF DRAWINGS

FIG. 1 is a perspective view illustrating the appearance of a wireless tag reading device according to an embodiment.

FIG. 2 is a perspective view illustrating the appearance of the above-described wireless tag reading device with a basket being housed.

FIG. 3 illustrates the above-described wireless tag reading device with the basket being housed, and is obtained by seeing through a side surface.

FIG. 4 is a plan view illustrating a part of a second display according to the embodiment.

FIG. 5 is a block diagram illustrating the hardware configuration of the above-described wireless tag reading device.

FIG. 6 illustrates the data configuration of a sensor information file unit of a memory unit according to the embodiment.

FIG. 7 illustrates the data configuration of a display mode file unit of the above-described memory unit.

FIG. 8 illustrates a display mode 1 of the second display device according to the embodiment.

FIG. 9 illustrates a display mode 2 of the above-described second display.

FIG. 10 illustrates a display mode 3 of the above-described second display.

FIG. 11 illustrates a display mode 4 of the above-described second display.

FIG. 12 illustrates a display mode 5 of the above-described second display.

FIG. 13 is a block diagram illustrating the functional configuration of the wireless tag reading device according to the embodiment.

FIG. 14 is a flowchart illustrating the flow of position display processing performed by a control unit of the above-described wireless tag reading device.

FIG. 15 is a flowchart illustrating the flow of reading processing performed by the control unit of the above-described wireless tag reading device.

### DETAILED DESCRIPTION

A wireless tag reading device of an embodiment includes: a housing portion formed by a bottom surface portion and a side surface portion erected upward from the bottom surface portion; an opening through which an article is allowed to be taken in and out of the housing portion; a reading unit that reads tag information from a wireless tag attached to the article housed in the housing portion via the opening by transmitting and receiving a radio wave to and from the wireless tag; a detection unit that detects a position of the article in the housing portion; and an announcement unit that makes an announcement to prompt approach of the article to a predetermined position of the housing portion based on output of the detection unit.

A wireless tag reading device of an embodiment will be described below with reference to the drawings. Although, in the present embodiment, an example in which the wireless tag reading device is connected to a POS terminal of a mass retailer and the like will be described, this is not a limitation. The wireless tag reading device may be used for, for example, component management in a factory, and can be widely applied to other fields.

A wireless tag reading device 1 is connected to, for example, a so-called self-point of sales (POS) terminal (not illustrated), which is disposed at a checkout counter of a mass retailer and used for a customer himself/herself to perform operations related to registration and settlement processing for a product (e.g., clothing and food) to be purchased. The wireless tag reading device 1 transmits and receives radio waves to and from a wireless tag attached to a product to be purchased by a customer, and reads a product code, which is information for identifying the product stored in the wireless tag. The product is one example of an article, and the product code is one example of tag information. Note that the wireless tag reading device 1 also reads, from the wireless tag, other information such as an individual product code for identifying an individual product.

The wireless tag reading device 1 transmits, to the self-POS terminal, the read product code and information related to a product (hereinafter, also referred to as product information) such as a product name and a price acquired from a memory unit to be described later based on the product code. The self-POS terminal executes settlement processing related to the product to be purchased by the customer based on the product code and the product information (hereinafter, also collectively referred to as product information and the like) received from the wireless tag reading device 1. Note that the wireless tag reading device 1 may directly read the product information from the wireless tag storing the product information.

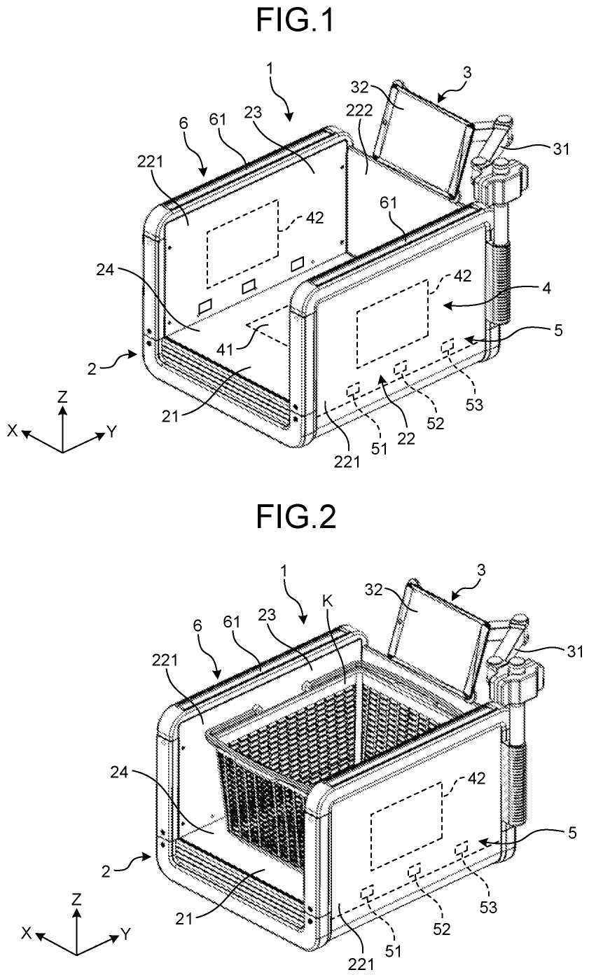

FIGS. 1 and 2 are perspective views illustrating the appearance of the wireless tag reading device 1 according to the embodiment. In FIG. 1, a basket K (see FIG. 2) is not housed. In FIG. 2, the basket K is housed. The basket K is one example of a housing body that stores an article. The wireless tag reading device 1 includes a housing portion 2 and a first display 3.

The housing portion 2 includes a bottom surface portion 21, a side surface portion 22, an upper surface opening 23, and a side surface opening 24. The side surface portion 22 erects upward from three sides of the bottom surface portion 21. The housing portion 2 forms reading space surrounded by the bottom surface portion 21 and the side surface portion 22. Furthermore, the bottom surface portion 21 and the side surface portion 22 have inner surfaces made of a material that transmits radio waves and outer surfaces made of a material that shields against radio waves. This causes the bottom surface portion 21 and the side surface portion 22 to serve as radio wave shield portions that prevent leakage of radio waves to the outside. Note that, in the following description, an arrow X direction, an arrow Y direction, and an arrow Z direction in FIG. 1 may be referred to as a right and left direction, a front and rear direction, and a height direction, respectively. Furthermore, in the front and rear direction, the side of the side surface opening 24 and the side of the first display 3 may be referred to as a front side and a rear side, respectively.

The bottom surface portion 21 has an inner surface made of a flat radio wave transmitting material. As illustrated in FIG. 2, the inner surface functions as a placement surface for placing the basket K in which a customer puts a product to be purchased. The bottom surface portion 21 has an outer surface including a radio wave reflector such as an aluminum metal plate. Furthermore, the bottom surface portion 21 includes a flat antenna to be described later between the inner surface and the outer surface. In other words, the bottom surface portion 21 has an embedded flat antenna.

The side surface portion 22 includes a pair of right and left side surface portions 221 and a rear side surface portion 222. The right and left side surface portions 221 face each other in the right and left direction. The side surface portion 22 has a height larger than that of the basket K. Consequently, a product housed up to an upper position of the basket K is sufficiently accommodated in the housing portion 2, and does not protrude upward from the housing portion 2.

Similarly to the bottom surface portion 21, the pair of right and left side surface portions 221 have inner surfaces formed of a flat radio wave transmitting material and outer surfaces including a flat radio wave reflector. Furthermore, the pair of right and left side surface portions 221 include flat antennas to be described later between the inner surfaces and the outer surfaces. Moreover, the pair of right and left side surface portions 221 have embedded radio wave absorbers (not illustrated) located outside the above-described antennas. The above-described radio wave absorbers are formed on surfaces extending from central portions of the pair of right and left side surface portions 221 in the vertical direction to the vicinities of upper ends. The radio wave absorbers include, for example, a flat plate of ferrite. Furthermore, the distance between the pair of right and left side surface portions 221 is slightly longer than the width of the basket K in the right and left direction. The pair of right and left side surface portions 221 have a function of guiding movement of the basket K in the front and rear direction in the housing portion 2.

The upper surface opening 23 functions as an inlet/outlet for taking the basket K in and out of the housing portion 2 from above. Similarly, the side surface opening 24 functions as an inlet/outlet for taking the basket K in and out of the housing portion 2 from the front. The basket K can be housed in the housing portion 2 from above and from the front, so that operability of a customer can be improved. In particular, the side surface opening 24 eliminates the need for the customer to lift the basket K containing a product high, so that the operability is improved. The side surface opening 24 is one example of an opening that is formed in the side surface portion 22 and that allows an article to be taken in and out of the housing portion 2.

The first display 3 is attached to the housing portion 2 via an arm 31 provided in the rear portion of one of the right and left side surface portions 221. The arm 31 can freely extend, move, and rotate upward or in the right and left direction. This allows the first display 3 to optionally set a display position and a display direction. The first display 3 includes, for example, a liquid crystal display, and displays various pieces of information to a customer and the like who operate the wireless tag reading device 1. For example, the first display 3 displays product information corresponding to tag information received from a wireless tag as a list of products to be purchased. Furthermore, when the wireless tag reading device 1 completes tag information reading operation for a wireless tag in the housing portion 2 (hereinafter, also referred to as reading completion), the first display 3 displays the reading completion. The first display 3 is one example of a reading completion announcing unit that announces completion of tag information reading.

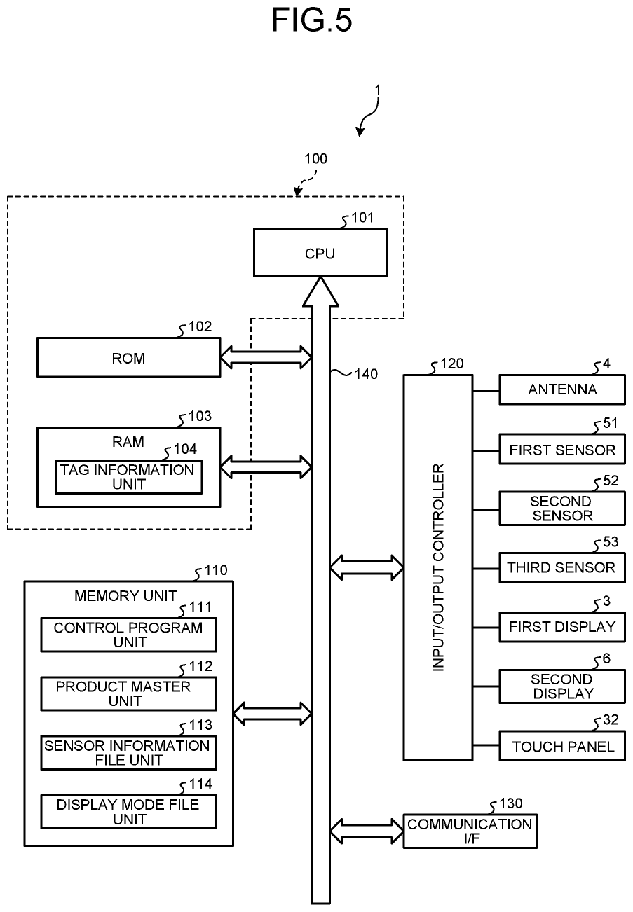

A touch panel 32 is provided on the surface of the first display 3. The touch panel 32 is used for inputting information in accordance with a touched position to a control unit 100 (see FIG. 5) of the wireless tag reading device 1, and functions as an operation input unit for a user to input an information by a user's operation.

The wireless tag reading device 1 further includes an antenna 4, a sensor 5, and a second display 6. The antenna 4 transmits and receives radio waves to and from a wireless tag. The sensor 5 detects the position of the basket K. The second display 6 performs display to prompt, for example, movement of the basket K.

The antenna 4 includes a flat bottom surface antenna 41 and a pair of flat side surface antennas 42. The bottom surface antenna 41 is embedded in the bottom surface portion 21. The side surface antennas 42 are embedded in the pair of right and left side surface portions 221.

The bottom surface antenna 41 has a rectangular shape, and the central portion thereof is located at a central portion of the bottom surface portion 21 in the front and rear direction and the right and left direction. Furthermore, the bottom surface antenna 41 is located between the upper surface of the bottom surface portion 21 and the internally provided radio wave reflector in the vertical direction. The bottom surface antenna 41 radiates radio waves mainly in the vertical direction.

The side surface antennas 42 have a rectangular shape, and the central portions thereof are located at central portions of the right and left side surface portions 221 in the front and rear direction and the height direction. Furthermore, the side surface antennas 42 are located between the inner surfaces of the right and left side surface portions 221 and the internally provided radio wave reflectors and radio wave absorbers in the right and left direction. The side surface antennas 42 radiate radio waves mainly in the right and left direction.

The antenna 4 including the bottom surface antenna 41 and the side surface antennas 42 transmits a radio wave in accordance with an instruction of the control unit 100, and receives a radio wave with which the wireless tag has responded (hereinafter, also referred to as response wave) to the radio wave transmitted by the antenna 4 (hereinafter, also referred to as carrier wave). The control unit 100 reads a product code based on the response wave received by the antenna 4. The antenna 4 constitutes a reading unit together with the control unit 100.

Furthermore, the radio waves transmitted by the bottom surface antenna 41 and the side surface antennas 42 have high directivity. Leakage of radio waves from the side surface opening 24 is thus prevented as much as possible. This is because erroneous reading is inhibited by preventing the bottom surface antenna 41 and the side surface antennas 42 from communicating radio waves with a wireless tag located outside the housing portion 2. This may result in a portion which radio waves do not sufficiently reach in the vicinities of a front end and a rear end of the housing portion 2. In other words, the wireless tag reading device 1 easily reads tag information of a wireless tag located at the central portion or the vicinity of the central portion of the housing portion 2. Thus, when the basket K housed in the housing portion 2 is placed at the central portion of the housing portion 2 in the front and rear direction, tag information of the wireless tag housed in the basket K is highly likely to be reliably read. Therefore, the central portion of the basket K containing a product is desirably placed at the central portion of the housing portion 2 in the front and rear direction at the time of reading tag information. The central portion of the housing portion 2 in the front and rear direction is one example of a predetermined position. At the predetermined position, tag information is highly likely to be reliably read in the housing portion 2. The predetermined position is determined by the arrangement of the antenna 4 and the like.

In the present embodiment, the central portion of the basket K can be located in the central portion of the housing portion 2 in the right and left direction by being guided by the pair of right and left side surface portions 221. Furthermore, since the housing portion 2 includes the rear side surface portion 222 including the shield portion, radio waves radiated from the antenna 4 can reach an end with low directivity toward the rear. Note that the upper surface of the housing portion 2 may be covered to further prevent leakage of radio waves. A product is, however, not usually disposed above the wireless tag reading device 1, and a risk of erroneous reading due to leakage of radio waves from the upper surface opening 23 is extremely low. Therefore, in the present embodiment, the upper surface opening 23 is provided to improve operability.

The sensor 5 includes a first sensor 51, a second sensor 52, and a third sensor 53. The first to third sensors 51 to 53 are provided at predetermined intervals in the front and rear direction. The first sensor 51, the second sensor 52, and the third sensor 53 are arranged in this order from the front. Note that, since the first to third sensors 51 to 53 have the same configuration, the first sensor 51 will be described as a representative.

The first sensor 51 includes a light emitting element and a light receiving element. The light emitting element is provided in one of the right and left side surface portions 221 facing each other. The light receiving element is provided on the other. The basket K is disposed between the light emitting element and the light receiving element, and shields against light from the light emitting element. The first sensor 51 thereby detects the basket K.

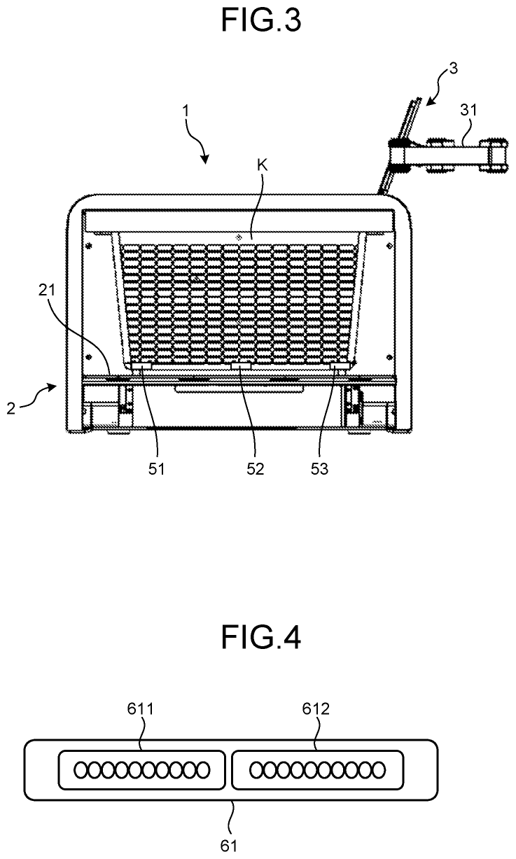

FIG. 3 illustrates a positional relation between the first to third sensors 51 to 53 and the basket K housed in the housing portion 2. As illustrated in FIG. 3, both the light emitting elements and the light receiving elements of the first to third sensors 51 to 53 are provided at predetermined heights from the bottom surface portion 21. The bottom of the basket K is located at the predetermined height position with the lattice-shaped basket K being housed in the housing portion 2. Since the bottom of the basket K is continuous in the front and rear direction, the basket K located in the housing portion 2 can be reliably detected by providing the first to third sensors 51 to 53 at the predetermined heights. The sensor 5 including the first to third sensors 51 to 53 is one example of a detection unit that detects the position of an article (product). Note that, although, in the present embodiment, the position of a product is indirectly detected by detecting the position of the basket K, the position of the product can be directly detected without using the basket K. Furthermore, although, in the present embodiment, the three sensors constitute the detection unit, a larger number of sensors may constitute the detection unit.

The second display 6 includes a pair of display units 61 provided at the upper ends of the right and left side surface portions 221. Since the pair of display units 61 have the same configuration, only one of the pair of display units 61 will be described. FIG. 4 is a plan view illustrating an upper surface of one display unit 61. The display unit 61 includes a first light emitting diode (LED) group 611 and a second LED group 612.

The first LED group 611 is located in front of the second LED group 612. Each of the first LED group 611 and the second LED group 612 includes a plurality of, for example, 10 LEDs. In the first LED group 611 and the second LED group 612, for example, all the LEDs are turned off, light, or blink to notify a user of various pieces of information. Furthermore, the first LED group 611 and the second LED group 612 can notify the user of information indicating a direction by, for example, performing an operation in which the LEDs sequentially blink from one side to the other side in the front and rear direction and thus emitted light appears to flow (hereinafter, also referred to as flow blinking). The second display 6 including the display units 61 is one example of an announcement unit that makes an announcement to prompt approach of an article to a predetermined position.

Next, the hardware configuration of the wireless tag reading device 1 will be described with reference to a block diagram. FIG. 5 is a block diagram illustrating the hardware configuration of the wireless tag reading device 1. The wireless tag reading device 1 includes the control unit 100, a memory unit 110, an input/output controller 120, a communication interface (I/F) 130, and the like. The control unit 100, the memory unit 110, the input/output controller 120, and the communication I/F 130 are connected to each other via a bus 140.

The control unit 100 is a computer including a central processing unit (CPU) 101, a read only memory (ROM) 102, and a random access memory (RAM) 103. The CPU 101, the ROM 102, and the RAM 103 are connected to each other via the bus 140.

The CPU 101 controls the overall operation of the wireless tag reading device 1. The ROM 102 stores various programs such as a program used for driving the CPU 101 and various pieces of data. The RAM 103 includes a tag information unit 104. The tag information unit 104 stores product information and the like related to tag information read by the wireless tag reading device 1. Specifically, the tag information unit 104 stores a read product code (tag information) and product information (e.g., product name and product price) acquired from a product master unit to be described later based on the product code. Furthermore, the RAM 103 is used as a work area of the CPU 101, and develops various programs and various pieces of data stored in the ROM 102 and the memory unit 110. The control unit 100 executes various pieces of control processing of the wireless tag reading device 1 by the CPU 101 operating in accordance with a control program, which is stored in the ROM 102 or the memory unit 110 and developed in the RAM 103.

The memory unit 110 is a storage device including a rewritable nonvolatile storage medium such as a hard disk drive (HDD), a solid state memory (SSD), and a flash memory. The memory unit 110 includes a control program unit 111, a product master unit 112, a sensor information file unit 113, and a display mode file unit 114. The control program unit 111 stores various control programs in addition to a control program for functioning as the wireless tag reading device 1.

The product master unit 112 stores a product master. The product master is a master file in which a product code and product information (e.g., product name and price) are stored in association with each other for a product handled in a store in which the wireless tag reading device 1 is installed. Since products handled in the store change every day, the product master is appropriately updated by a self-POS terminal or a store server (not illustrated) connected via the communication I/F 130.

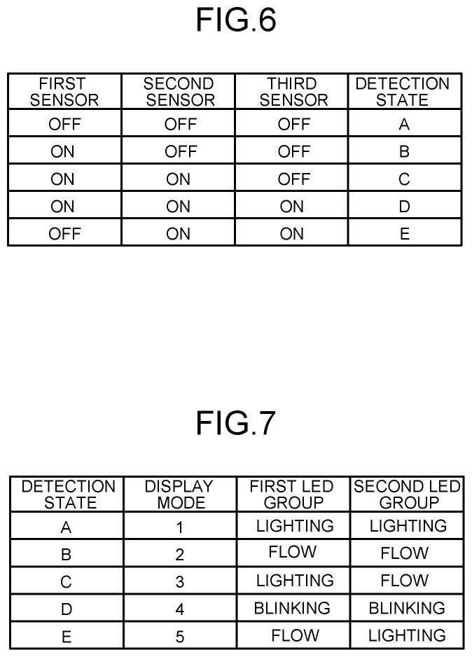

The sensor information file unit 113 stores a sensor information file. FIG. 6 illustrates the data configuration of the sensor information file unit 113. In the sensor information file, outputs of the first to third sensors 51 to 53 and detection states of the position of the basket K are stored in association with each other. The outputs of the first to third sensors 51 to 53 are turned on when the basket K is detected. Details of each of detection states A to E will be described later.

The display mode file unit 114 stores a display mode file. FIG. 7 illustrates the data configuration of the display mode file unit 114. In the display mode file, the detection states of the position of the basket K, display modes of the second display 6, operations of the first LED group 611, and operations of the second LED group 612 are stored in association with each other. The “flow” in the operation of the first LED group 611 and the operation of the second LED group 612 indicates the above-described “flow blinking”. Details of the operation of the first LED group 611 and the operation of the second LED group 612 will be described later.

Returning to FIG. 5, the input/output controller 120 is connected to the antenna 4, the first to third sensors 51 to 53, the first display 3, the second display 6, and the touch panel 32. The input/output controller 120 has a function as an input/output interface for connected hardware and a function for controlling the hardware. This allows the control unit 100 to transmit and receive information (data) to and from each of the antenna 4, the first to third sensors 51 to 53, the first display 3, the second display 6, and the touch panel 32 via the input/output controller 120 while the hardware can be controlled based on an instruction of the control unit 100. The communication I/F 130 is used for communicating with the self-POS terminal.

Subsequently, the position detection state of the basket K and display operation of the second display 6 based on the sensor information file unit 113 and the display mode file unit 114 will be described.

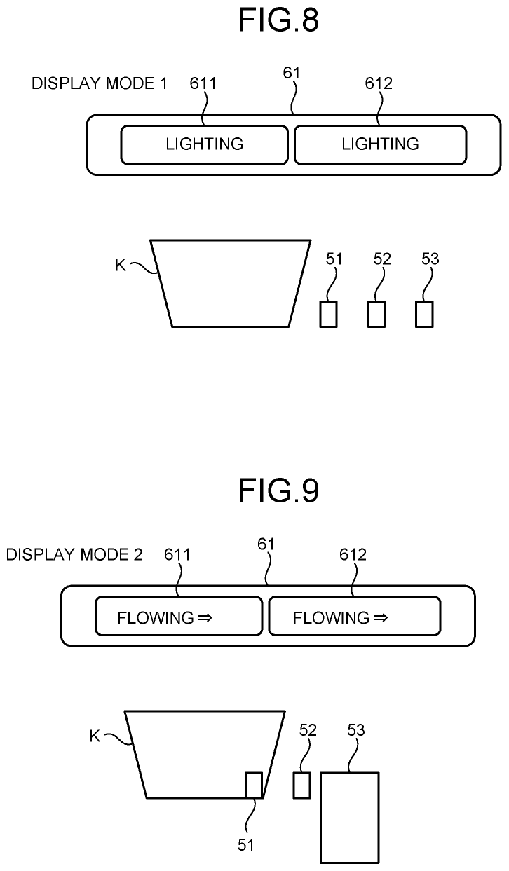

FIG. 8 illustrates a state in which the basket K is not located in the housing portion 2 and a display mode of the display unit 61 at that time. Since the basket K is not located in the housing portion 2, all the first to third sensors 51 to 53 are turned off. The control unit 100 detects the detection state A. The display unit 61 performs display in a display mode determined by the display mode file unit 114 in FIG. 7. Specifically, display operation is performed in a display mode 1 corresponding to the detection state A. That is, all the LEDs of the first LED group 611 and the second LED group 612 light. This allows the display unit 61 to notify a customer that the wireless tag reading device 1 can be used.

FIG. 9 illustrates a state in which a part of the basket K is located in the housing portion 2 at, for example, an initial stage of the operation of putting the basket K from the side surface opening 24 into the housing portion 2 and a display mode of the display unit 61 at that time. Note that, when the basket K is put from the upper surface opening 23 into the housing portion 2, the basket K may be placed at this position. At the time, the first sensor 51 is on, and the second sensor 52 and the third sensor 53 are off. The control unit 100 detects the detection state B. The display unit 61 performs display operation in a display mode 2 corresponding to the detection state B. Specifically, the first LED group 611 and the second LED group 612 perform the flow blinking from the front toward the rear. This allows the display unit 61 to perform display to prompt the customer to move the basket K rearward to a predetermined position. The second display including the display unit 61 is one example of a display that displays a direction in which an article is to be moved.

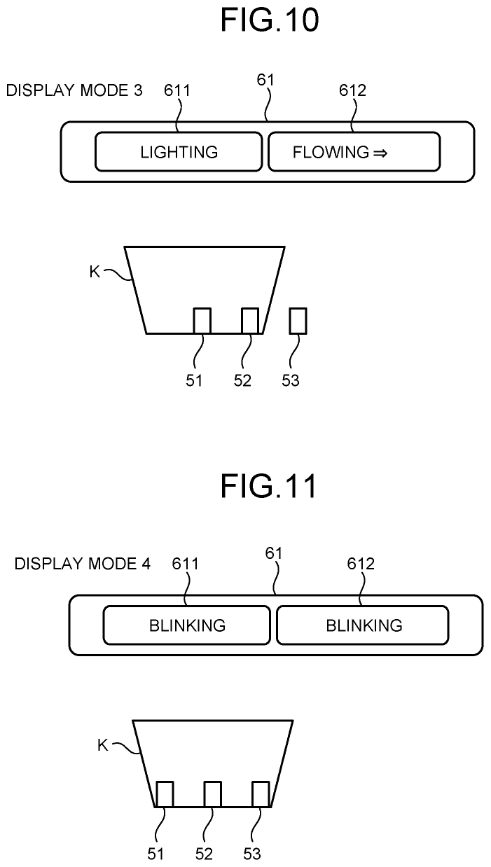

FIG. 10 illustrates a state in which the basket K is located more rearward than in the state in FIG. 9 and a display mode of the display unit 61 at that time. At the time, the first sensor 51 and the second sensor 52 are on, and the third sensor 53 is off. The control unit 100 detects the detection state C. The display unit 61 performs display operation in a display mode 3 corresponding to the detection state C. Specifically, all the LEDs of the first LED group 611 light, and the second LED group 612 performs flow blinking from the front toward the rear. This allows the display unit 61 to perform display to prompt the customer to move the basket K rearward. In addition, since only the second LED group 612 performs the flow blinking, the display unit 61 can sensuously notify the customer that an amount of movement to the predetermined position is smaller than in the display mode 2 in FIG. 9. The second display including the display unit 61 is also one example of a display that changes the display mode in accordance with a movement amount of movement of an article.

FIG. 11 illustrates a state in which the basket K is located in the central portion (predetermined position) of the housing portion 2 and a display mode of the display unit 61 at that time. At the time, the first to third sensors 51 to 53 are on. The control unit 100 detects the detection state D. The display unit 61 performs display operation in a display mode 4 corresponding to the detection state D. Specifically, all the LEDs in the first LED group 611 and the second LED group 612 blink. This allows the display unit 61 to notify the customer that the basket K is located at a predetermined position optimal for reading tag information.

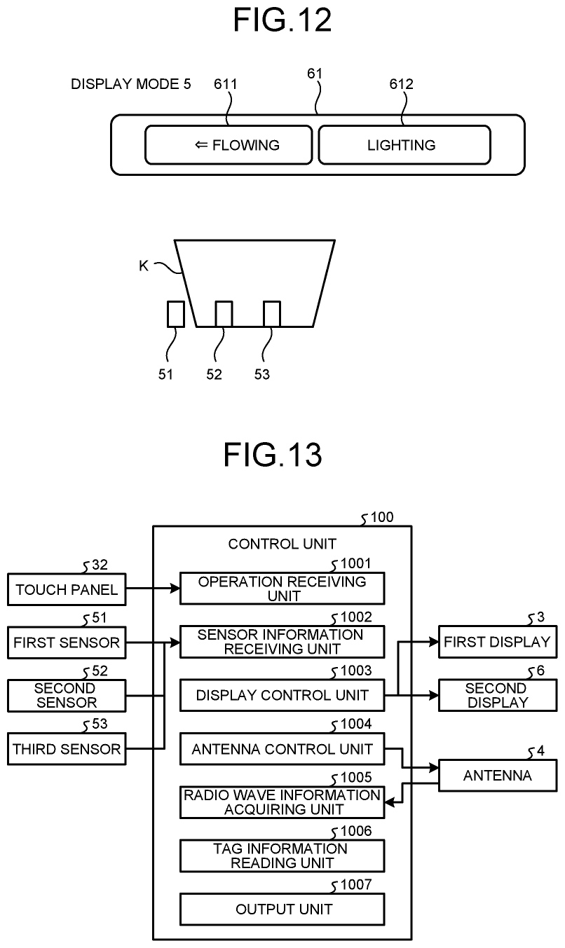

FIG. 12 illustrates a state in which the basket K is located more rearward than a predetermined position and a display mode of the display unit 61 at that time. In the housing portion 2 and the basket K described in the present embodiment, the rear side surface portion 222 restricts rearward movement of the basket K, so that the basket K is not located more rearward than the predetermined position. In a store adopting a small basket K, however, the basket K may be located more rearward than the predetermined position. Furthermore, when the housing portion 2 does not include the rear side surface portion 222, the basket K may be located more rearward than the predetermined position. Then, when the basket K is located more rearward than the predetermined position, the first sensor 51 is off, and the second sensor 52 and the third sensor 53 are on. The control unit 100 detects the detection state E. The display unit 61 performs display operation in a display mode 5 corresponding to the detection state E. Specifically, the first LED group 611 performs flow blinking from the rear toward the front, and all the LEDs of the second LED group 612 light. This allows the display unit 61 to perform display to prompt the customer to move the basket K forward.

In this way, the second display 6 performs display to prompt movement of the basket K to the central portion (predetermined position) of the housing portion 2, and thus performs display to prompt approach of a product housed in the basket K to the central portion of the housing portion 2. Note that the above-described display example is merely one example, and an announcement method for prompting movement can be appropriately set. For example, the position of the basket K may be simply displayed, or announcement may be made by voice.

Next, the functional configuration of the wireless tag reading device 1 including a functional configuration for achieving the above-described display operation will be described. FIG. 13 is a block diagram illustrating the functional configuration of the wireless tag reading device 1.

The control unit 100 functions as an operation receiving unit 1001, a sensor information receiving unit 1002, a display control unit 1003, an antenna control unit 1004, a radio wave information acquiring unit 1005, a tag information reading unit 1006, and an output unit 1007 by the CPU 101 operating in accordance with a control program stored in the ROM 102 or the control program unit 111 of the memory unit 110. Note that each of these functional configurations may be configured by hardware.

The operation receiving unit 1001 receives an operation signal from the touch panel 32. For example, the operation receiving unit 1001 receives, from the touch panel 32, a signal indicating a reading start instruction and a signal indicating a settlement instruction based on the read tag information.

The sensor information receiving unit 1002 receives sensor information (on/off information) from the first sensor 51, the second sensor 52, and the third sensor 53. The sensor information receiving unit 1002 receives sensor information indicating the presence or absence of detection of the basket K from the first to third sensors 51 to 53.

The display control unit 1003 controls the first display 3 and the second display 6. For example, the display control unit 1003 causes the first display 3 to display product information based on the tag information read by the tag information reading unit 1006, and further causes the first display 3 to display information indicating that the tag information reading operation has been completed. Furthermore, for example, the display control unit 1003 causes the second display 6 to perform display to prompt movement of the basket K to the predetermined position based on the sensor information received by the sensor information receiving unit 1002.

The antenna control unit 1004 controls the antenna 4. For example, when receiving sensor information indicating that the sensor information receiving unit 1002 has detected the basket K, the antenna control unit 1004 controls the antenna 4 to transmit a carrier wave. Furthermore, when the tag information reading operation is completed, the antenna control unit 1004 controls the antenna 4 to stop the transmission of the carrier wave. Note that the antenna control unit 1004 performs the same control on the bottom surface antenna 41 and the pair of side surface antennas 42.

The radio wave information acquiring unit 1005 acquires radio wave information from the antenna 4. Specifically, the radio wave information acquiring unit 1005 acquires waveform information of a response wave received by the antenna 4 from the wireless tag.

The tag information reading unit 1006 reads tag information from the waveform information acquired by the radio wave information acquiring unit 1005. Specifically, the tag information reading unit 1006 analyzes the waveform information acquired by the radio wave information acquiring unit 1005, and reads information indicating a product code included in the waveform information. Furthermore, the tag information reading unit 1006 also reads an individual product code for identifying an individual product from the waveform information acquired by the radio wave information acquiring unit 1005. The individual product code is also one example of the tag information.

The output unit 1007 outputs product information based on the tag information read by the tag information reading unit 1006 to the self-POS terminal. Specifically, the output unit 1007 refers to the product master unit 112, reads product information corresponding to the product code read by the tag information reading unit 1006, and outputs the product information and the like to the self-POS terminal. The self-POS terminal performs settlement processing based on the input product information and the like.

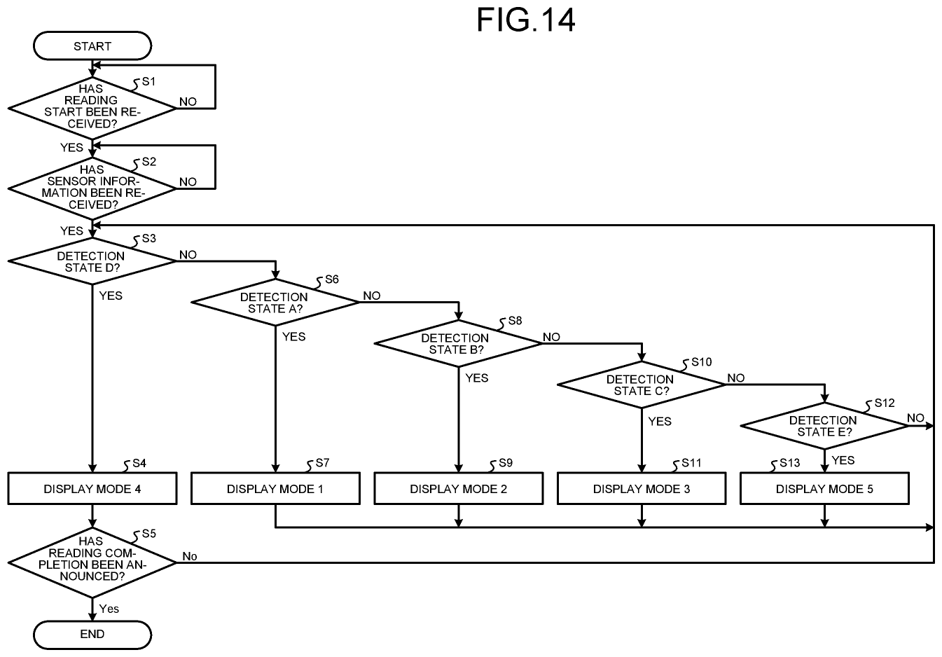

Next, processing (hereinafter, also referred to as position display processing) of the control unit 100 for executing the display operation of the second display 6 in FIGS. 8 to 12 will be described. FIG. 14 is a flowchart illustrating the flow of the position display processing.

The control unit 100 determines whether or not the operation receiving unit 1001 has received a reading start instruction from the touch panel 32 (S1), and if not (N in S1), stands by. When the operation receiving unit 1001 receives the reading start instruction (Y in S1), the control unit 100 determines whether or not the sensor information receiving unit 1002 has received sensor information indicating that the basket K has been detected from at least one of the first to third sensors 51 to 53 (S2), and if not (N in S2), returns to the processing of S2, and stands by. Note that, after the operation receiving unit 1001 receives the reading start instruction, the second display 6 may perform display in the display mode 1 for notifying a customer that the wireless tag reading device 1 can be used.

When the sensor information receiving unit 1002 receives the sensor information (Y in S2), the display control unit 1003 reads a detection state corresponding to the sensor information of the first to third sensors 51 to 53 received by the sensor information receiving unit 1002, and determines whether or not the detection state is D (S3). When the detection state is D (Y in S3), the display control unit 1003 determines that the basket K is placed at a predetermined position, and causes the second display 6 to display the display mode 4 (see FIG. 11) (S4).

Subsequently, the control unit 100 determines whether or not tag information reading operation for a wireless tag in the basket K has been completed (S5), and if completed (Y in S5), ends the position display processing. When not completed (N in S5), the control unit 100 returns to the processing of S3.

In the processing of S3, when the detection state is not D (N in S3), the display control unit 1003 determines whether or not the detection state is A (S6). When the detection state is A, the display control unit 1003 causes the second display 6 to display the display mode 1 (see FIG. 8) (S7). Next, the control unit 100 returns to the processing of S3.

When the detection state is not A (N in S6), the display control unit 1003 determines whether or not the detection state is B (S8). When the detection state is B, the display control unit 1003 causes the second display 6 to display the display mode 2 (see FIG. 9) (S9). Next, the control unit 100 returns to the processing of S3.

When the detection state is not B (N in S8), the display control unit 1003 determines whether or not the detection state is C (S10). When the detection state is C, the display control unit 1003 causes the second display 6 to display the display mode 3 (see FIG. 10) (S11). Next, the control unit 100 returns to the processing of S3.

When the detection state is not C (N in S10), the display control unit 1003 determines whether or not the detection state is E (S12). When the detection state is E, the display control unit 1003 causes the second display 6 to display the display mode 5 (see FIG. 12) (S13). Next, the control unit 100 returns to the processing of S3. The above-described processing is performed to perform display to prompt the customer to move the basket K to the predetermined position. Since various electronic components including the first to third sensors 51 to 53 have sufficiently high operation speeds, the second display 6 can switch the display following the movement of the basket K performed by the customer.

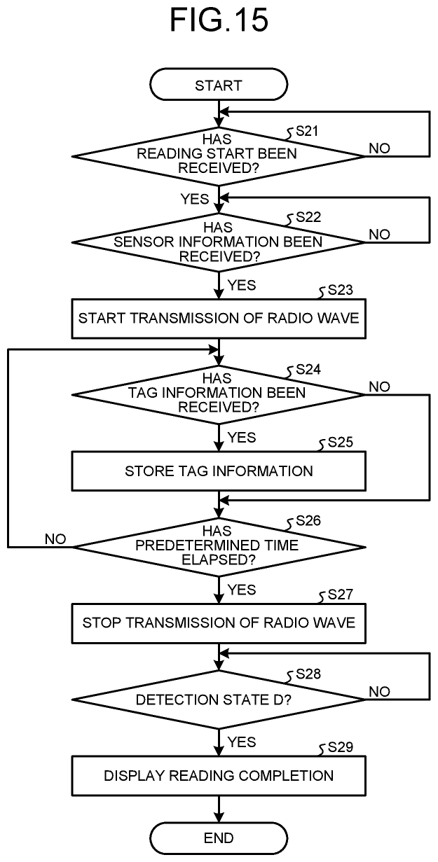

Next, processing of the control unit 100 for executing tag information reading (hereinafter, also referred to as reading processing) performed by the wireless tag reading device 1 will be described. FIG. 15 is a flowchart illustrating the flow of the reading processing.

The control unit 100 determines whether or not the operation receiving unit 1001 has received a reading start instruction from the touch panel 32 (S21), and if not (N in S21), stands by. When the operation receiving unit 1001 receives the reading start instruction (Y in S1), the control unit 100 determines whether or not the sensor information receiving unit 1002 has received sensor information indicating that the basket K has been detected from at least one of the first to third sensors 51 to 53 (S2), and if not (N in S2), returns to the processing of S2, and stands by.

When the sensor information receiving unit 1002 receives the sensor information (Y in S22), the antenna control unit 1004 controls the antenna 4 to start transmission of a carrier wave (S23). Then, the control unit 100 determines whether or not the tag information reading unit 1006 has read the tag information (S24). Specifically, the control unit 100 determines whether or not the tag information reading unit 1006 has read a product code based on the waveform information of the response wave acquired by the radio wave information acquiring unit 1005 from the antenna 4.

When the tag information reading unit 1006 reads the product code (Y in S24), the tag information reading unit 1006 refers to the product master unit 112, reads the product information (e.g., product name and product price) corresponding to the read product code, and stores the product information and the like in the tag information unit 104 (S25). Then, the control unit 100 determines whether or not a predetermined time has elapsed since the antenna control unit 1004 causes the antenna 4 to start transmission of a carrier wave (S26), and if not (N in S26), returns to the processing of S24. Note that the predetermined time is a time sufficient for the antenna 4 to communicate with the wireless tags attached to all products in the basket K, and is preset based on an experiment or the like. When the above-described predetermined time elapses, the tag information reading operation is completed.

In the processing of S24, when the tag information reading unit 1006 does not read the tag information (N in S24), the control unit 100 skips the processing of S25, and proceeds to the processing of S26. In the processing of S26, when the predetermined time has elapsed (Y in S26), the antenna control unit 1004 controls the antenna 4 to stop the transmission of the carrier wave (S27).

Subsequently, the display control unit 1003 determines whether or not the detection state is D based on the sensor information received by the sensor information receiving unit 1002 (S28). When the detection state is D (Y in S28), the display control unit 1003 causes the first display 3 to display the fact that the tag information reading has been completed (S29), and ends the reading processing. When the detection state is not D (N in S28), the control unit 100 returns to the processing of S28.

As described above, when one of the first to third sensors 51 to 53 detects the basket K, in other words, when the basket K is located in the housing portion 2, the wireless tag reading device 1 starts the tag information reading. Then, even when a predetermined time has elapsed since the start of reading and the tag information reading unit 1006 completes the tag information reading operation, the display control unit 1003 does not cause the first display 3 to display reading completion unless the detection state is D. That is, the first display 3 displays the reading completion on condition that the basket K is disposed at the predetermined position guided by the second display 6. This is because, if the reading completion is displayed with the basket K being not located at the predetermined position in spite of the fact that the second display 6 is guiding the basket K to the predetermined position, the customer has senses of strangeness and uncertainty. Note that, usually, if the basket K is moved in the housing portion 2 in accordance with display of the second display 6, reading of tag information from the wireless tag in the basket K can be performed within a predetermined time. Thus, there is no problem if the reading operation is completed before the basket K is disposed at the predetermined position. The antenna control unit 1004, however, may stop output of a carrier wave from the antenna 4 on condition that the detection state based on the sensor information received by the sensor information receiving unit 1002 is D, that is, the basket K is disposed at the predetermined position.

As described above, the wireless tag reading device 1 of the present embodiment includes: the housing portion 2 formed by the bottom surface portion 21 and the side surface portion 22 erected upward from the bottom surface portion 21; the side surface opening 24 that is formed in the side surface portion 22 and that allows the basket K to be taken in and out of the housing portion 2; the antenna 4 and the tag information reading unit 1006 that read a product code from a wireless tag attached to a product in the basket K housed in the housing portion 2 via the side surface opening 24 by transmitting and receiving a radio wave to and from the wireless tag; the first to third sensors 51 to 53 that detect the position of the basket K in the housing portion 2; and the second display 6 that performs display to prompt approach of the product in the basket K to a predetermined position based on outputs of the first to third sensors 51 to 53. Thus, the customer can take the basket K in and out of the housing portion 2 from the side surface opening 24 without lifting the basket K high. In addition, even if a portion which radio waves are difficult to reach is set in the housing portion 2 in order to inhibit leakage of radio waves from the side surface opening 24, the customer can move the basket K to a position where the tag information is easily read. Therefore, according to the wireless tag reading device 1 of the present embodiment, operability can be improved while erroneous reading is inhibited.

Furthermore, the first to third sensors 51 to 53 of the present embodiment are located at positions of predetermined heights from the bottom surface portion 21, and detect the position of the basket K containing a product. Thus, the first to third sensors 51 to 53 can reliably detect even the lattice-shaped basket K by being provided at positions corresponding to the bottom of the basket K.

Moreover, the second display 6 of the present embodiment displays a direction in which the basket K is to be moved by the flow blinking using the LED. Thus, the customer can sensuously understand the direction in which the basket K is to be moved, and can easily dispose the basket K at the predetermined position.

In addition, the second display 6 of the present embodiment performs different displays in accordance with a movement amount of movement of the basket K. Specifically, when an amount (distance) in which the basket K is to be moved is large, both the first LED group 611 and the second LED group 612 perform display by flow blinking. When the amount in which the basket K is to be moved is small, only one LED group performs display by flow blinking. Thus, the customer can sensuously understand not only the direction in which the basket K is to be moved but the amount of movement. Therefore, the customer can more easily dispose the basket K at the predetermined position.

In addition, in the present embodiment, when one of the first to third sensors 51 to 53 detects the basket K, the antenna 4 starts the transmission of a carrier wave and the tag information reading unit 1006 starts the tag information reading even in a state where the basket K is not disposed at the predetermined position. Thus, the tag information reading unit 1006 can read the tag information from the wireless tag in the basket K while the basket K is moving to the predetermined position. The positional relation between the antenna 4 and the wireless tag in the basket K varies during the movement of the basket K. This causes the tag information of a wireless tag located at a position where radio waves from the antenna 4 are difficult to be received to be easily read. Therefore, the wireless tag reading device 1 of the present embodiment can improve the reading performance of the tag information.

Furthermore, the first display 3 of the present embodiment displays information indicating the completion of the tag information reading on condition that the first to third sensors 51 to 53 detect that the basket K has been disposed at the predetermined position. Thus, the first display 3 does not display the information indicating the completion of the reading with the basket K being not located at the predetermined position guided by the second display 6, which inhibits the customer to have senses of strangeness and uncertainty.

Note that, in the above-described embodiment, the control program executed by the wireless tag reading device 1 may be provided by being recorded in a computer-readable recording medium such as a CD-ROM. Furthermore, the control program executed by the wireless tag reading device 1 of the above-described embodiment may be provided by being stored on a computer connected to a network such as the Internet and downloaded via the network. Moreover, the control program may be provided via a network such as the Internet.

Although the embodiment of the present invention has been described above, the embodiment is presented as an example, and is not intended to limit the scope of the invention. The embodiment can be implemented in various other forms, and various omissions, substitutions, and changes can be made without departing from the gist of the invention. The embodiment and variations thereof are included in the scope and gist of the invention, and are included in the invention described in claims and the equivalent scope thereof.

1. A wireless tag reading device comprising:
a housing portion formed by a bottom surface portion and a side surface portion erected upward from the bottom surface portion;
an opening through which an article is allowed to be taken in and out of the housing portion;
a reading unit that reads tag information from a wireless tag attached to the article housed in the housing portion via the opening by transmitting and receiving a radio wave to and from the wireless tag;
a detection unit that detects a position of the article in the housing portion; and
an announcement unit that makes an announcement for a user to prompt approach of the article to a predetermined position of the housing portion based on output of the detection unit.

2. The wireless tag reading device according to claim 1,
wherein the detection unit is provided at a position of predetermined height from the bottom surface portion, and detects a position of a housing body that houses the article.

3. The wireless tag reading device according to claim 1,
wherein the announcement unit is a display that displays a direction in which the article is to be moved.

4. The wireless tag reading device according to claim 3,
wherein the display adopts different display modes in accordance with a movement amount of movement of the article.

5. The wireless tag reading device according to claim 1,
wherein, when the detection unit detects a position of the article, the reading unit starts reading even in a case where the article is not disposed at the predetermined position.

6. The wireless tag reading device according to claim 1, further comprising a reading completion announcing unit that announces completion of tag information reading operation performed by the reading unit,
wherein the reading completion announcing unit announces completion of tag information reading on condition that the detection unit detects that the article has been disposed at the predetermined position.
